(19) United States
(12) Patent Application Publication
(10) Pub. No.: US 2008/0307312 A1
(43) Pub. Date: Dec. 11, 2008

(54) USER INTERFACE DEVELOPMENT TOOLS

(75) Inventors: Pankaj Misra, Kanpur (IN); Navin Shankar Patel, Mysore (IN); Ratul Ahuja, Pantnagar (IN)

Correspondence Address: KLARQUIST SPARKMAN, LLP, 121 SW SALMON STREET, SUITE 1600, PORTLAND, OR, 97204, US

(73) Assignee: Infosys Technologies Ltd., Bangalore (IN)

(21) Appl. No.: 12/134,108

(22) Filed: Jun. 5, 2008

(30) Foreign Application Priority Data
Jun. 8, 2007 (IN) 1183/CHE/2007

(51) Int. Cl. G06F 3/048

(52) U.S. Cl. 715/733

(57) ABSTRACT

A user interface tool can use a repository of user interface elements to create a user interface. One or more of the elements in the repository can be reused within the interface or among multiple interfaces. At least some of the elements have associated behavioral information. The behavioral information can indicate how an element is to function or appear based on, for example, the device or business channel in which the user interface is used. The tool can employ a multi-layer architecture. At least some behaviors of the tool (e.g., which elements from the repository are presented to the user, which actions the user can perform on a user interface) can be dependant on one or more roles of the user.

### FIELD

This disclosure generally relates to software user interfaces.

### CROSS-REFERENCE TO RELATED APPLICATION

This application claims the benefit of Indian provisional patent application 1183/CHE/2007, filed Jun. 8, 2007, that is incorporated herein by reference.

### BACKGROUND

Sometimes, two or more user interfaces share elements that are the same or similar. For example, a first web page and a second web page can have input fields for a customer's contact or account information. As a more specific example, in some cases a web page requesting information for a checking account and a web page requesting information for a savings account use several similar and/or identical elements. Recreating such elements for each user interface can be costly and time-consuming. Additionally, a given element may not necessarily work as desired across multiple software or hardware platforms.

### SUMMARY

A user interface tool can use a repository of user interface elements to create a user interface. One or more of the elements in the repository can be reused within the interface or among multiple interfaces. At least some of the elements have associated behavioral information. The behavioral information can indicate how an element is to function or appear based on, for example, the device or business channel in which the user interface is used. The tool can employ a multi-layer architecture. At least some behaviors of the tool (e.g., which elements from the repository are presented to the user, which actions the user can perform on a user interface) can be dependent on one or more roles of the user.

In some examples, one or more computer-readable media comprising instructions configured to cause a computer to perform a method are provided. The method comprises reading a description of a user interface element associated with a user interface and reading a description of a business group associated with the interface. Based at least in part on the business group associated with the interface, the user interface element in the user interface is displayed. In some examples, the user interface element is displayed as a first element type if the business group associated with the user interface is a first business group or as a second element type if the business group associated with the user interface is a second business group. Displaying the user interface element based at least in part on the business group associated with the interface can further comprise displaying the user interface element as a first element type if the business group associated with the user interface is a first business group, and displaying the user interface element as a second element type if the business group associated with the user interface is a second business group, wherein the first and second element types are different. The description of the user interface element can identify the first and second element types. In further examples, displaying the user interface element based at least in part on the business group associated with the user interface comprises rendering the user interface element based at least in part on one or more business rules associated with the business group. Also, the method can further comprise displaying the user interface element based at least in part on an indication of a platform on which the user interface is configured to run. The user interface element can be configured to be displayed as a first element type if the user interface is configured to run on a first platform, and wherein the user interface element is configured to be displayed as a second element type if the user interface is configured to run on a second platform. In additional examples, the user interface element is configured to accept a first input type if the business group associated with the interface is a first business group, and wherein the user interface element is configured to accept a second input type if the business group associated with the interface is a second business group, wherein the first and second input types are different. The user interface can be associated with a user interface workflow, and the user interface element is displayed based at least in part on the interface workflow.

In other examples, methods comprise reading a description of a user interface element associated with a user interface and reading a description of a business rule associated with the user interface element. The user interface element is displayed in the user interface based at least in part on the business rule associated with the user interface element. In some cases, the business rule indicates that the user interface element should not be displayed in the user interface unless a given condition is satisfied. These methods can be described, on one or more computer-readable media, by instructions configured to cause a computer to perform the methods.

In further examples, systems comprise a first computer configured to run a software tool for modifying a user interface, wherein the user interface is associated with one or more business groups, and a second computer configured to receive instructions from a user and provide the instructions to the first computer. One or more computer-readable media comprising descriptions of elements that can be included in the user interface are provided, wherein the descriptions associate one or more element aspects with the one or more business groups. The software tool can be configured to receive a user role indicator and, based at least in part on the user role indicator, make available to the user one or more elements for inclusion in the user interface. In further examples, the software tool can be configured to receive a user role indicator and, based at least in part on the user role indicator, limit degree to which the user can modify the user interface. The system can further comprise one or more devices configured to receive and display the user interface. The system can also comprise a translation component configured to receive a description of a new user interface element and add a translated version of the new user interface element to the one or more computer-readable media. In some cases, the software tool is configured to simulate at least a portion of the user interface. In further examples, the system comprises a presentation layer, a business layer and a persistence layer.

One or more computer-readable media comprise a software description of a user interface element. The software description comprises an indication of a first business group, a description of a first element behavior associated with the first business group, an indication of a second business group, and a description of a second element behavior associated with the second business group, wherein the first element behavior is different from the second element behavior. In some examples, at least one of the first or second element behaviors is associated with a platform type for a user interface. The description can further comprise a description of a business rule associated with the user interface element. In further examples, the description comprises a third element behavior associated with a first user type and a fourth element behavior for a second user type.

These and other features and aspects are described below with reference to the accompanying drawings.

### BRIEF DESCRIPTION OF THE DRAWINGS

FIG. 1 shows a block diagram of an exemplary system for developing an interface.

FIG. 2 shows an exemplary embodiment of a hierarchy of elements.

FIG. 3 shows an exemplary embodiment of a user interface for the tool of FIG. 1.

FIG. 4 shows the user interface of FIG. 3 with an exemplary added element. FIG. 5 shows exemplary embodiments of interface pages.

FIG. 6 shows exemplary embodiments of an element used on different platforms.

FIG. 7 is a block diagram of an exemplary embodiment of a user interface workflow.

FIG. 8 shows a diagram of an exemplary embodiment of a layer architecture.

FIG. 9 shows a diagram of an exemplary embodiment of a layer architecture.

FIG. 10 shows a flowchart for an exemplary embodiment of a method used by a presentation layer.

FIG. 11 shows a flowchart for an exemplary embodiment of a method used by a business layer.

FIG. 12 shows a flowchart for an exemplary embodiment of a method used by a persistence layer.

FIG. 13 is a block diagram of a network as can be used to perform any of the disclosed methods or to generate any of the disclosed interface embodiments.

FIG. 14 is a schematic block diagram of a distributed computing network as may be used to perform any of the disclosed methods or to generate any of the disclosed interface embodiments.

FIG. 15 is a flowchart illustrating how an embodiment of the disclosed interfaces can be generated in the network of FIG. 13 or FIG. 14.

### DETAILED DESCRIPTION

Disclosed below are embodiments of user interface technologies and/or related systems and methods. The embodiments should not be construed as limiting in any way. Instead, the present disclosure is directed toward all novel and nonobvious features and aspects of the various disclosed methods, apparatus, and equivalents thereof, alone and in various combinations and subcombinations with one another. The disclosed technology is not limited to any specific aspect or feature, or combination thereof, nor do the disclosed methods and apparatus require that any one or more specific advantages be present or problems be solved.

As used in this application and in the claims, the singular forms “a,” “an” and “the” include the plural forms unless the context clearly dictates otherwise. Additionally, the term “includes” means “comprises.” The phrase “and/or” can mean “and,” “or” and “one or more of” the elements described in the sentence. Embodiments described herein are exemplary embodiments of the disclosed technologies unless clearly stated otherwise.

Although the operations of some of the disclosed methods and apparatus are described in a particular, sequential order for convenient presentation, it should be understood that this manner of description encompasses rearrangement, unless a particular ordering is required by specific language set forth below. For example, operations described sequentially can in some cases be rearranged or performed concurrently. Moreover, for the sake of simplicity, the attached figures may not show the various ways in which the disclosed methods and apparatus can be used in conjunction with other methods and apparatus.

Any of the methods described herein can be performed or simulated (at least in part) using software comprising computer-executable instructions stored on one or more computer-readable storage media. Furthermore, any intermediate or final results of the disclosed methods can be stored on one or more computer-readable storage media. Any such software can be executed on a single computer or on a networked computer (for example, via the Internet, a wide-area network, a local-area network, a client-server network, or other such network). For clarity, only certain selected aspects of the software-based implementations are described. Other details that are well known in the art are omitted. For the same reason, computer hardware is not described in further detail. It should be understood that the disclosed technology is not limited to any specific computer language, program, or computer. For instance, a wide variety of commercially available computer languages, programs, and computers can be used. In particular embodiments, at least portions of the disclosed technologies are implemented in JavaServer Faces (JSF) and asynchronous JavaScript and XML (Ajax).

Typically a user interface comprises a series of displayed items such as text entry boxes or radio buttons that are associated with selected display regions on a display monitor. For example, activating a mouse button with a mouse pointer displayed at a selected display region can be associated with selection of a particular radio button, or can locate a displayed cursor in preparation for text entry in a text box. User interface drop-down menus can be displayed in response to a menu entry selection signal provided by a user selection device such as a mouse, keyboard, or the device that provides a display pointer at a corresponding display location. While user interfaces are commonly graphical user interfaces, audio or tactical or other user interfaces or combinations thereof can be used.

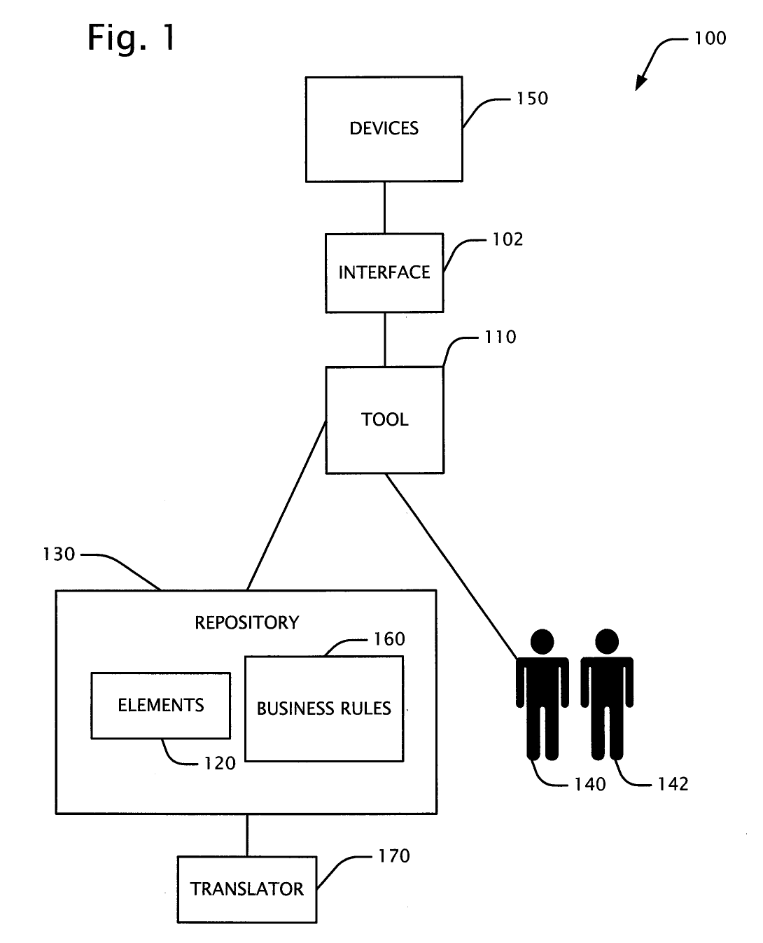

FIG. 1 shows a block diagram of a system 100 for developing and/or using a user interface 102. The interface 102 can be created and/or modified by one or more users 140, 142 using a tool 110. The interface 102 comprises one or more element instances that are based on elements 120 that can be stored in a repository 130. Typically, the repository 130 can be arranged as database and stored in one or more computer readable storage media that are accessible via a local area network, a wide area network, or that are available locally. The elements 120 are generally stored in the repository 130 as a series of one or more computer-executable or computer-interpretable instructions in a convenient programming language. In addition or alternatively, visual or audible representations can be stored. For example, an element that provides a labeled text entry box can be stored as the associated computer-executable instructions for generating the labeled text entry box along with a corresponding image. In typical examples, the users 140, 142 can develop the user interface 102 without knowledge of the underlying computer executable instructions, and the user interface 102 is developed using a graphical user interface based on stored and/or generated images. In some embodiments, the tool 110 of other program or software module is configured to test the interface 102, including testing behavioral information associated with elements of the interface. 102.

The interface 102 can be viewed using one or more devices 150. The devices 150 can include, for example, a desktop computer, a laptop computer, a wireless communication device, a personal digital assistant (PDA), an automatic teller machine (ATM) and/or additional devices. As used in this application and in the claims, a “user interface” is not limited to visual elements (e.g., buttons, images, text boxes) but can also include non-visual elements configured for audio input/out, and logical rules related to the interface, as explained in more detail below. The elements 120 on which the user interface 102 is based can be configured based on a targeted user device to accommodate user input/output device characteristics. For example, in text entry from PDA or laptop, a full keyboard is available, while for wireless communication devices such as cell phones, only a limited keyboard is available.

Some embodiments of the system 100 comprise a translation component 170 that is configured to receive descriptions of one or more elements from one or more interfaces (e.g., elements and/or interfaces not necessarily created or modified with the technology of the system 100) and add these elements to the repository 130. In some cases, the translation component 170 can create a description of behavioral information for one or more of these elements. Some versions of the translation component 170 can require that an added component originally use the same JSF framework as the system 100, but other versions of the component 170 do not have this requirement.

In some embodiments, the tool 110 can be functionally organized in a plurality of layers. This can allow the tool 110 to interact with other applications, such as web-based applications and/or a distributed computing system. In at least some cases, a layer-based architecture can allow for reusability and/or stability in a first layer when a second layer is modified. For example, a given layer can be “unaware” of how an operation (e.g., data storage and/or retrieval) is handled by another layer.

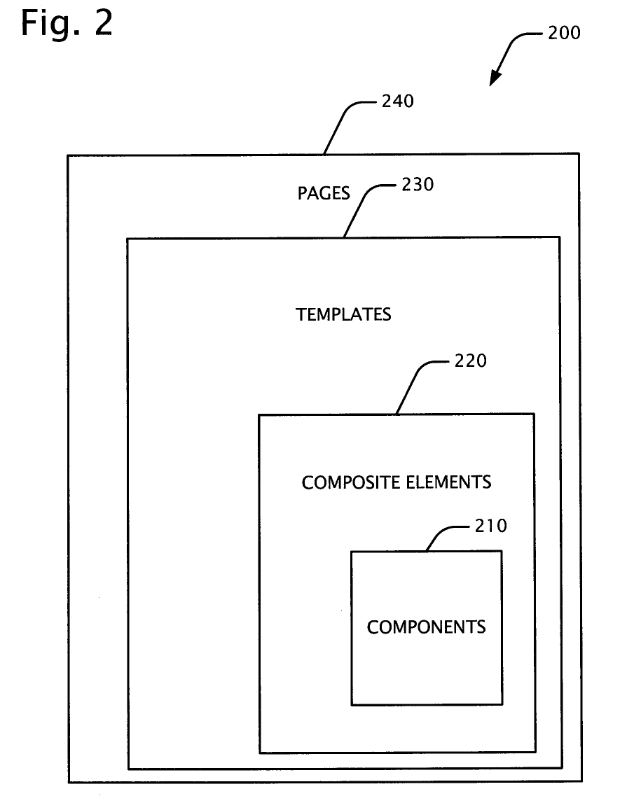

FIG. 2 shows an exemplary embodiment of a hierarchy 200 of the elements 120. In the hierarchy 200, the most basic elements are components 210. In some embodiments, components can include buttons, check boxes, dropdown lists, images, labels, radio buttons, text boxes, and/or image buttons. In further embodiments the components can include additional items. One or more components 210 can form a composite element 220. One exemplary embodiment of a composite element 220 is a text box and an associated label for the text box. In other examples, a composite element includes a series of radio buttons and associated labels, or a drop down menu and labels for menu selections.

One or more components 210 and/or one or more composite elements 220 can be arranged to form a template 230. One exemplary embodiment of a template 230 is a set of composite elements 220 for gathering name and contact information (e.g., for a customer). In this example template, several text entry boxes and labels are provided. In another example of a template, a customer information template can includes a plurality of radio boxes and labels to identify customer gender, age range, marital status, order shipping or payment preferences as well as text entry boxes and labels. A page 240 can comprise one or more components 210, composite elements 220 and/or templates 230. In some embodiments, a page 240 is configured for display by one or more software applications, for example, in a web browser. The arrangement of FIG. 2 is only an example, and additional embodiments, one or more other hierarchies can be used. In some cases, the hierarchy can be modified by the users 140, 142.

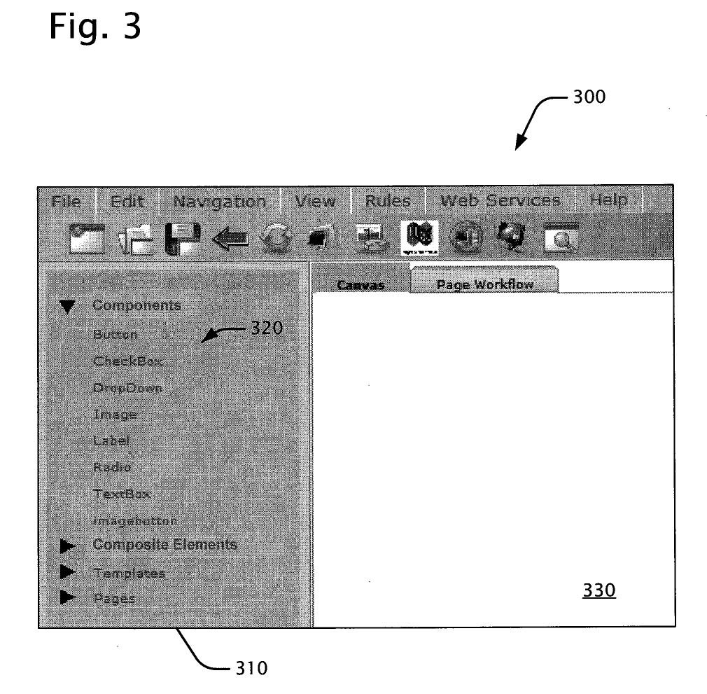

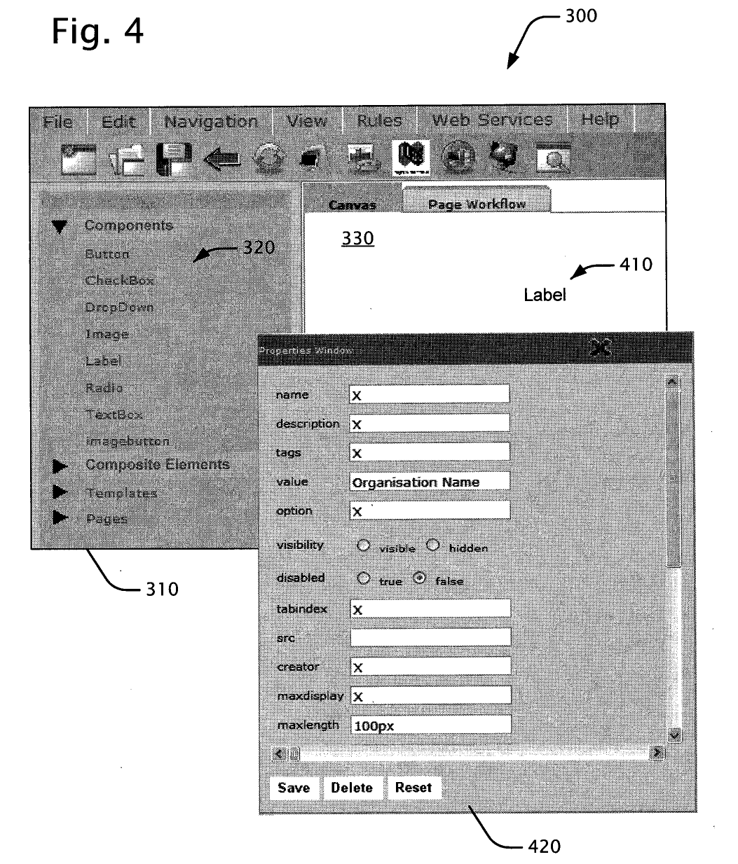

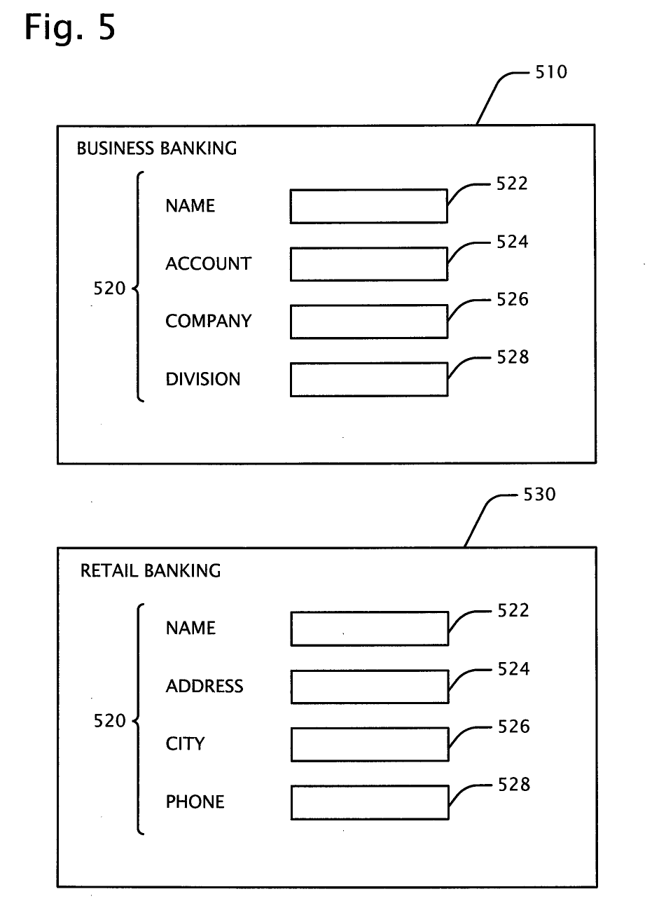

The elements 120 can be modified by a user through a variety of software interfaces. FIG. 3 shows an exemplary embodiment of an interface 300. An element pane 310 displays a list 320 of elements organized according to a hierarchy such as the hierarchy 200. In the depicted embodiment, elements can be selected from the list 320 and arranged in a canvas pane 330. For example, FIG. 4 shows the interface 300 where an instance 410 of the element “Label” has been placed in the canvas pane 330. Such placements can be made, for example, by dragging an element from the pane 310 and dropping the element in the canvas pane 330, using a command line function or a pointing device such as a mouse or trackball, or by other methods. The properties of one or more elements can be modified using, for example, a properties window 420.

In additional versions of the disclosed technologies, one or more web services can be linked to a given element. For example, a user can select access to one or banking services (account services such as transfers and balance information), financial services (investment portfolio evaluation and planning), or research services (investment returns, interest rate histories) In further embodiments, programming components (e.g., macros or scripts) can be linked to a given element. For example, a particular element can be used in conjunction with completion of a transaction such as a balance transfer, bill payment, or product purchase. The tool 110 can display input and/or output parameters for the web services or programming components to be associated with a particular element instance.

Generally, one or more elements 120 can be stored in the repository 130 and used in creating the interface 102 as well as other interfaces. For example, a user 140 can create a page for collecting customer contact information (e.g., name, address, account number) as part of an interface. The user 140 can store the page in the repository 130, and the page can be used for collecting customer contact information in another interface. Although this example deals specifically with reusing pages, one or more other elements 120 (e.g., templates 230, composite elements 220, and/or components 210) can also be reused within other elements in an element hierarchy. For example, in some embodiments, a composite element 220 can be reused within a template 230 or a page 240. In at least some cases, the reuse of one or more elements can allow for more efficient creation of the interfaces 102, since an element does not necessarily need to be created from scratch each time it is incorporated into an interface. Reuse of one or more elements can also allow for some degree of consistency across multiple interfaces 102 (e.g., can help maintain a “look and feel” across interfaces).

At least some of the elements stored in the repository 130 can have associated behavioral data. Generally, behavioral data describes how an element 120 acts and/or appears based on, for example: inputs; settings; and/or hardware and software with which the interface 102 is used or intended to be used. For example, behavioral data can describe how a text box should handle inputs that contain invalid characters or procedures to be followed in response to repeated login failures based on invalid passwords. In some examples, invalid inputs can be used to trigger prompts to a user, or to inform a user how to fix the input. For example, a password entry text box can be associated with a series of instructions that display to a user one or more characteristics of permitted passwords, or that user input is currently associated with keyboard data entry with a “Caps Lock” key activated. In other examples, text entry boxes can be associated with permitted withdrawal amounts, available times for transfers or payments, or minimum account balances.

As a further example, behavioral information can describe procedures that can initiated or completed in response to an element instance or how an element instance appears when associated with one or more “business channels” or “business groups) for which the interface is designed. In this application and in the claims, a “business channel” or “business group” generally refers to a line of business or a particular portion of an industry. For example, in the banking industry two business channels could be “business banking” and “retail banking.” In additional embodiments, a hierarchy of elements (such as that shown in FIG. 2) can vary according to the one or more business channels associated with an interface.

In one example related to business channel information, an element designed to receive a ZIP code is configured to require nine digits (i.e., a ZIP+4 code) when it is associated with a “mortgage” business channel, but only five digits when it is associated with a “retail banking” business channel.

As another example, FIG. 5 shows a page 510 from an interface associated with a business banking channel. The page 510 comprises an instance of a composite element 520 which contains fields 522, 524, 526, 528 for receiving customer name, account, company and division information, respectively. One or more aspects of at least some of the fields 522, 524, 526, 528 (e.g., the respective field labels) are displayed based on business channel information. FIG. 5 also shows a page 530 from an interface associated with a retail banking channel. In this case, the page 530 comprises another instance of the composite element 520. However, as the business channel information indicates that the interface for page 530 is for retail banking, aspects of some of the fields 522, 524, 526, 528 shown for the page 530 differ from the aspects shown for these fields in the page 510. For example, the labels of the fields 524, 526, 528 differ between the pages 510, 530. In further embodiments, one or more elements can be shown or hidden based at least in part on business channel information for an interface.

One or more behaviors of the repository 130 can depend on the business channel with which the interface 102 is associated. For example, a user 140 employing the tool 110 to create the interface 102 can indicate one or more business channels for the interface 102. In view of the indicated business channels, the elements 120 made available to the tool 110 by the repository 130 can vary and/or be presented differently. For example, if the indicated business channel is “mortgages,” the repository 130 can display to the user 140 an element for calculating mortgage payments, while this element can be hidden for other business channels. As another example, as seen in the pages 510, 530, the repository 130 can show a given component as having different properties based on the indicated business channel for an interface.

In further embodiments, behavioral data for an element instance can describe procedures available based on the displayed element instance or how the element instance appears as a result of one or more applicable business rules 160, as shown in FIG. 1. In this application and in the claims a “business rule” describes one or more events that must occur or conditions which must be fulfilled in order to allow a given action. In one example, a business rule for a savings account may require that an account cannot be closed unless the account has been open for at least six months. An exemplary element associated with this rule does not provide a “Close Account” button on a user interface for a savings account unless the account satisfies this condition. Alternatively, such a button can be displayed but in a different color or different intensity (“grayed out”), indicating a function that is commonly available, but that is not currently available.

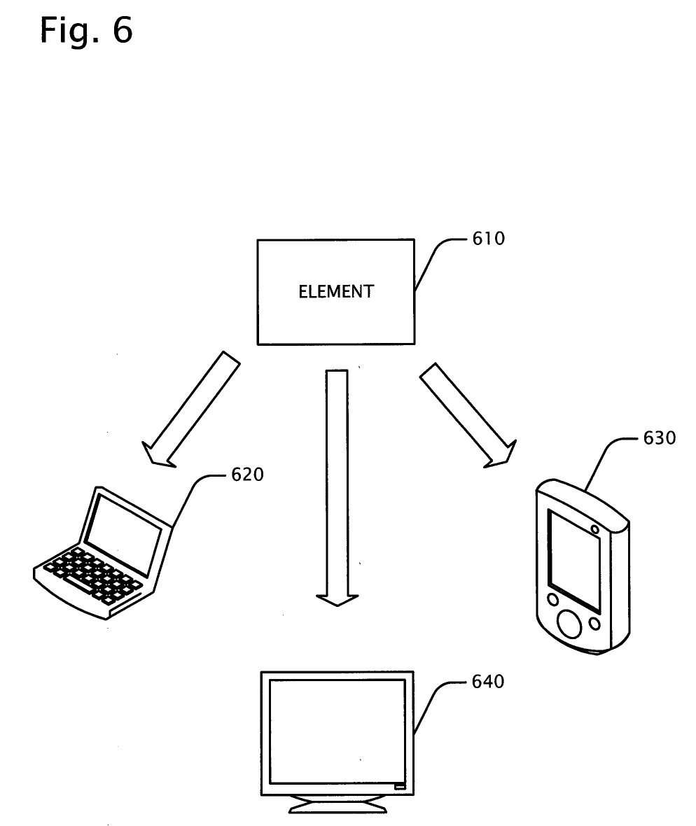

In additional embodiments, the behavior of an element instance can depend at least in part on the platform on which the element instance is being used. In this context, “platform” can refer to a particular type of device 150 (e.g., a desktop computer, laptop computer, PDA) and/or software (e.g., an operating system or application). In one example, shown in FIG. 6, a “display balance” element instance 610 is configured for a desktop or laptop web browser 620 to show an account balance and information regarding one or more recent account transactions. On a wireless communication device browser 630 or an ATM screen 640, however, the “display balance” element instance 610 is configured to show only the account balance or otherwise provide a more limited display of account data based on display capacity. Element behavior on a particular platform can be selected, for example, when the element is instantiated in the tool 110. In further embodiments the element behavior is selected at one or more other times.

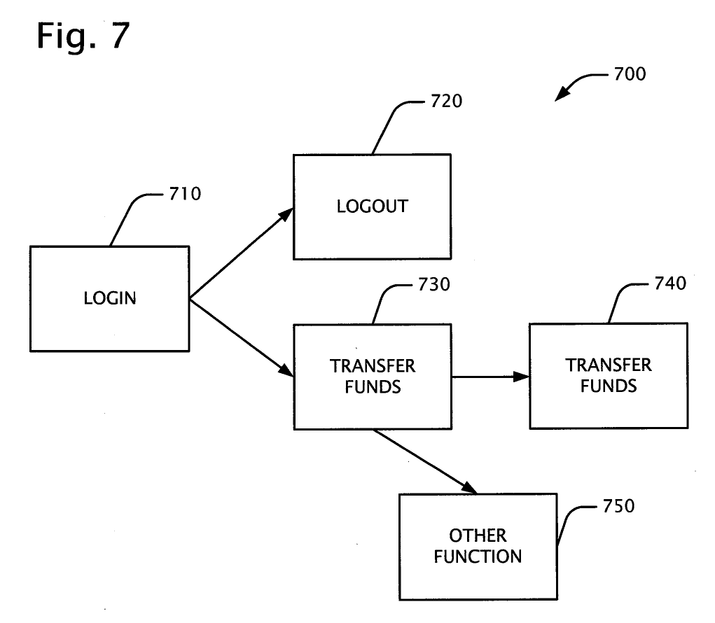

Additional embodiments of the disclosed technologies can allow the tool 110 to create a workflow for the interface 102. In this application and in the claims, a “workflow” describes how a user proceeds through one or more stages of the interface 102 based on, for example, inputs from the user. FIG. 7 shows a block diagram of one exemplary embodiment of a retail banking workflow 700 for the interface 102. In this example, the workflow 700 begins with a login stage 710. Once the user logs in, the user can proceed to a logout stage 720 or a transfer funds stage 730, and possibly to additional stages 740, 750.

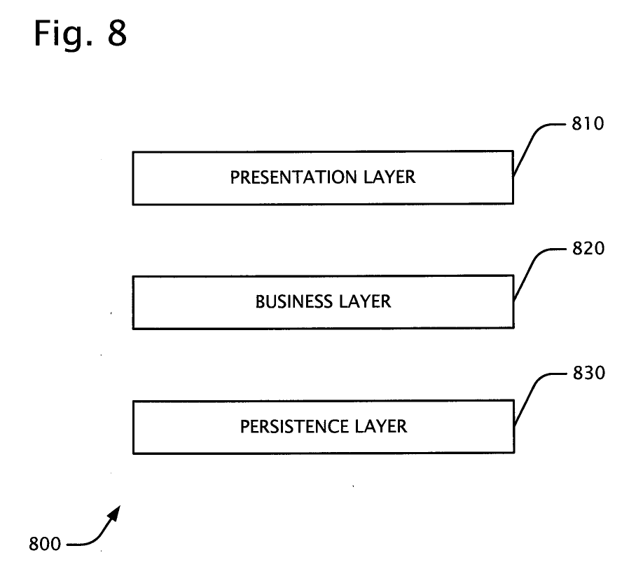

FIG. 8 shows a diagram of one embodiment of a layer architecture 800 for the tool 110. The architecture 800 comprises a presentation layer 810, a business layer 820 and a persistence layer 830. In further embodiments the architecture 800 includes one or more other layers.

The presentation layer 810 is configured to handle presentation logic that is associated with appearance, placement, and organization of user interface elements are presented to a user. Typically, locations, colors, sizes, and other visual details are included. Instructions received from via the user interface of the tool 110 (e.g., changes to elements in an interface 102) are processed in the presentation layer 810. As explained below, handling events frequently involves interacting with the business layer 820. The business layer 820 is configured to handle business rules, to handle requests from the presentation layer 810, and to interact with the persistence layer 830 as needed by the presentation layer 810. The persistence layer 830 is configured to handle data storage and access operations associated with one or more database.

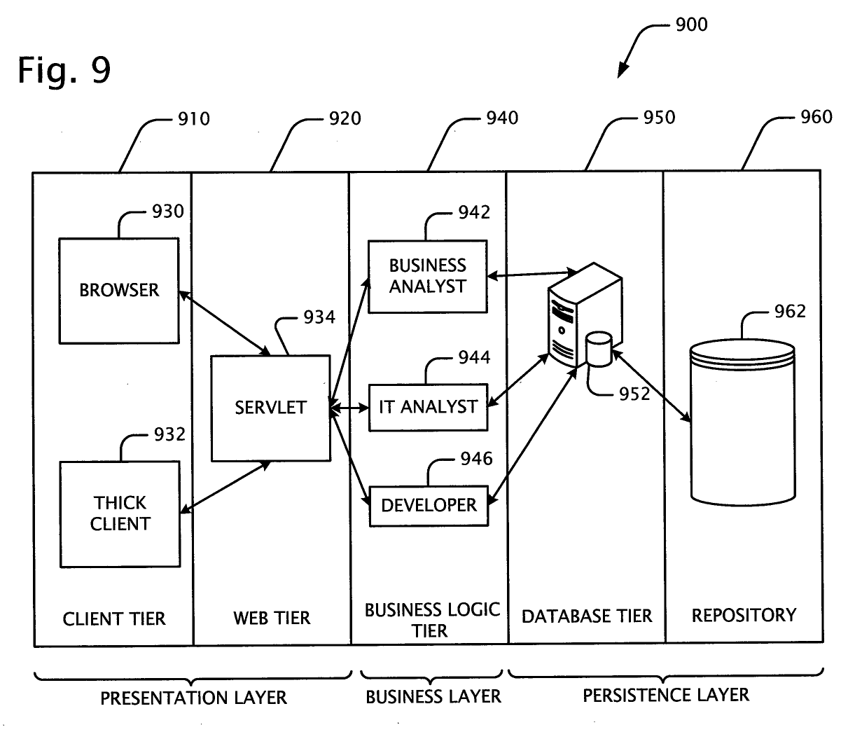

FIG. 9 illustrates the layer architecture 900 for the tool 110. In the depicted embodiment, the presentation layer comprises a client tier 910 and a web tier 920. The client tier 910 comprises a browser 930 or a thick client 932, which can communicate with a servlet 934 (or with another component that receives a request and generates a response based on the request) in the web tier 920. The presentation layer is generally employed by the users 140, 142 to send commands to other layers in the architecture 900 and to view results of those commands (e.g., the results of modifying an element in the interface 102).

The business layer comprises a business logic tier 940, which is configured to handle user queries from the presentation layer. The business logic tier 940 comprises logic which provides different levels of abstraction for various types of users (e.g., users who have different types of roles and/or permissions). The depicted embodiment comprises business analyst logic 942, IT analyst logic 944 and developer logic 946. A user viewing an interface 102 through an abstraction provided by the business analyst logic 942 can, for example, review a constructed design and place approvals for further action. A user viewing an interface 102 through an abstraction provided by the developer logic 946 can, for example, modify the interface 102 at a low level (e.g., by changing element properties, adding elements and/or removing elements). A user viewing in interface as an IT analyst can assemble and test a user interface based on elements and combinations thereof, but modification of elements is not provided. In the depicted embodiment, interactions between the client tier 910, the web tier 920 and the business logic tier 940 are handled by Hypertext Transfer Protocol (HTTP). In further embodiments, one or more other protocols can be used.

The persistence layer comprises a database tier 950 and a repository 960. The database tier 950 comprises a database system with one or more tables 952 describing the interface 102. For example, the tables 952 can include one or more tables for describing pages used in the interface 102, for describing the page workflow of the interface 102, and for describing elements used in the interface 102. The repository 960 comprises a database 962 for storing elements, business rules and other data that can be used in defining the interface 102. In the depicted embodiment, interactions between the business logic tier 940, the database tier 950 and the repository 960 are handled by Java Database Connectivity (JDBC) calls. In further embodiments, one or more other protocols can be used.

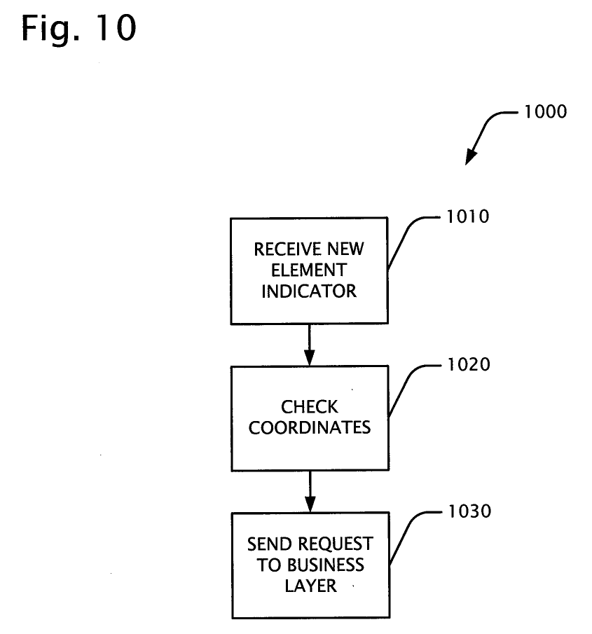

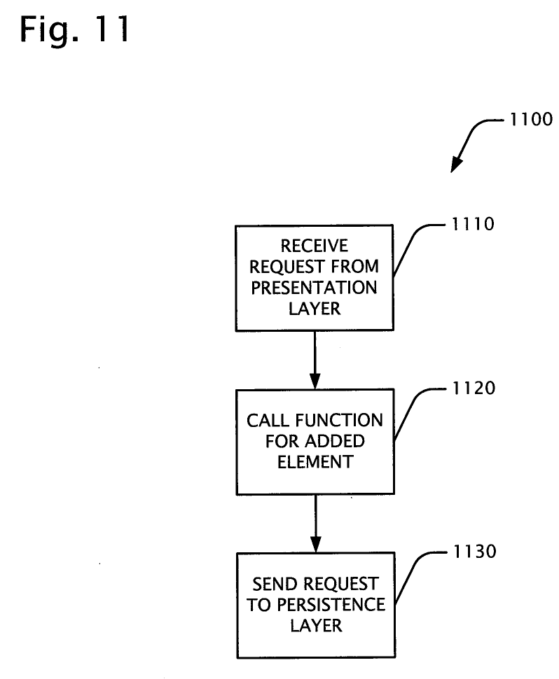

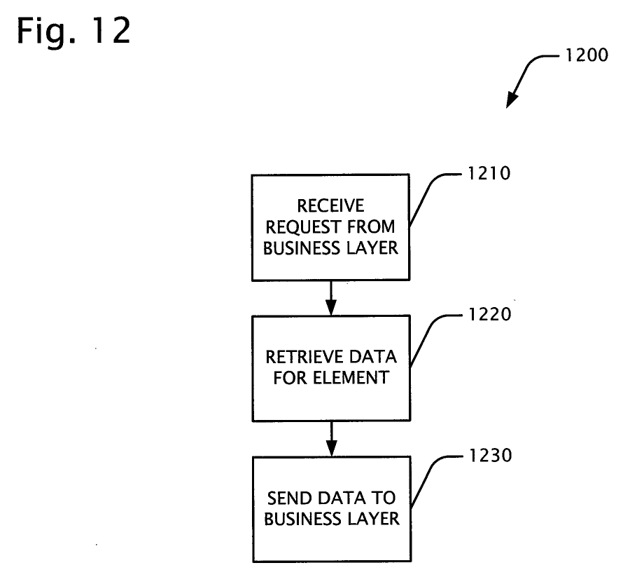

FIGS. 10-12 depict flowcharts of exemplary embodiments of methods used by the layers 810, 820, 830 to add a new element to the interface 102. In this method, the flowchart 1000 of FIG. 10 depicts method acts performed by the presentation layer 810. The presentation layer 810 receives an indication of a new element (method act 1010), for example, as a result of a user dragging the element onto the canvas. The layer 810 determines the indicated coordinates of the new element (method act 1020) and, in some embodiments, checks whether the coordinates are valid for the element. The layer 810 sends a request to the business layer 820 describing the new element (method act 1030). The flowchart 1100 of FIG. 11 depicts method acts performed by the business layer 820. The business layer 820 receives from the presentation layer 810 the request describing the new element (method act 1110). The layer 820 calls an appropriate function to request data for the added element (method act 1120) and sends a request to the persistence layer 830 (method act 1130). As shown in the flowchart 1200 of FIG. 12, the persistence layer 830 receives the request from the business layer 820 (method act 1210), retrieves data for the new element (method act 1220), and sends the data to the business layer 820 (method act 1230). The business layer 820 passes the data to the presentation layer 810, which renders the new element for the user.

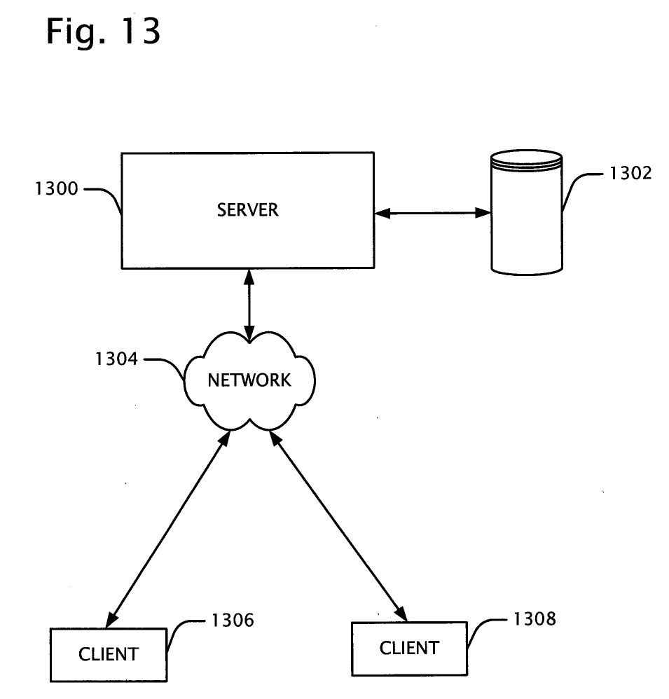

Any of the aspects of the technology described above may be performed using a distributed computer network. FIG. 13 shows one suitable exemplary network. A server computer 1300 can have an associated storage device 1302 (internal or external to the server computer). For example, the server computer 1300 can be configured to generate any of the disclosed interface embodiments. The server computer 1300 can be coupled to a network, shown generally at 1304, which can comprise, for example, a wide-area network, a local-area network, a client-server network, the Internet, or other suitable network. One or more client computers, such as those shown at 1306, 1308, may be coupled to the network 1304 using a network protocol. The work may also be performed on a single, dedicated workstation, which has its own memory and one or more CPUs.

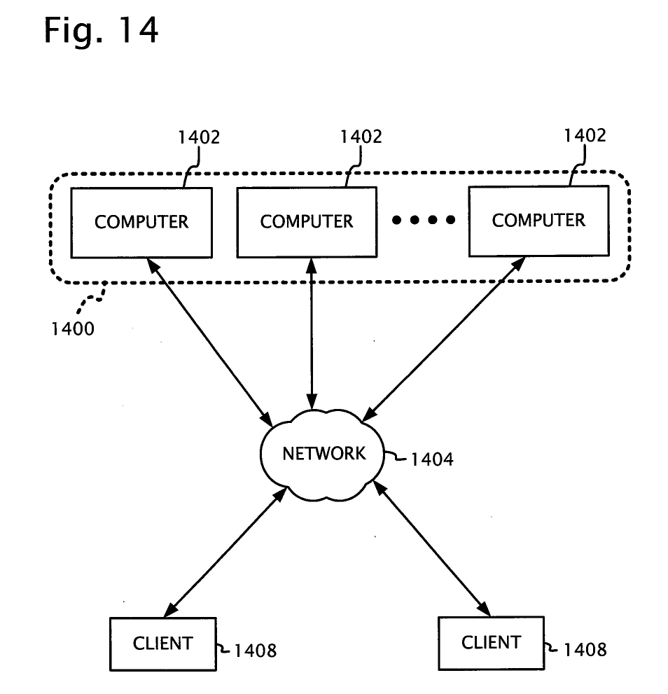

FIG. 14 shows another exemplary network. One or more computers 1402 communicate via a network 1404 and form a computing environment 1400 (for example, a distributed computing environment). Each of the computers 1402 in the computing environment 1400 can be used to perform at least a portion of the interface generating process. The network 1404 in the illustrated embodiment is also coupled to one or more client computers 1408.

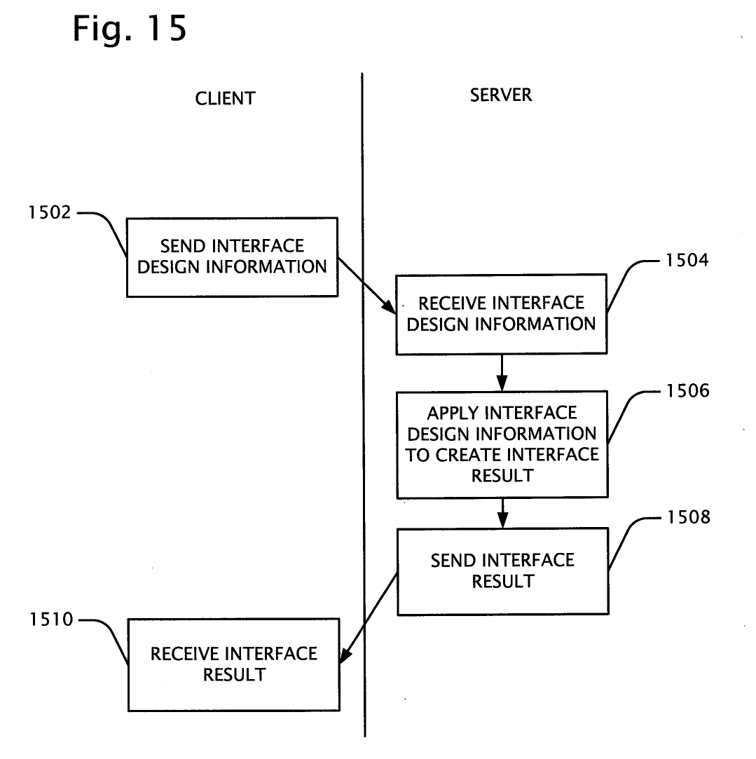

FIG. 15 shows that an interface can be designed (e.g., created and/or modified) according to the disclosed technologies using a remote server computer (such as the server computer 1300 shown in FIG. 13) or a remote computing environment (such as the computing environment 1400 shown in FIG. 14). At method act 1502, for example, the client computer sends interface design information (e.g., a command to add a new element to an interface or modify an aspect of an existing element) to the remote server or computing environment. In method act 1504, the interface design information is received and loaded by the remote server or by respective components of the remote computing environment. In method act 1506, the interface design information is applied to create an interface result (e.g., an element is added and/or modified). At method act 1508, the remote server or computing environment sends the interface result to the client computer, which receives the result at method act 1510.

It should be apparent to those skilled in the art that the example shown in FIG. 15 is not the only way to generate any of the disclosed interface embodiments using multiple computers. For instance, the interface design information may be stored on a computer-readable medium that is not on a network and that is sent separately to the server or computing environment (for example, a CD-ROM, DVD, or portable hard drive). Or, the server computer or remote computing environment can perform only a portion of the hardware design procedures. Similar procedures using a remote server or computing environment can be performed to design interfaces.

Having illustrated and described the principles of the disclosed technology, it will be apparent to those skilled in the art that the disclosed embodiments can be modified in arrangement and detail without departing from such principles. In view of the many possible embodiments, it will be recognized that the illustrated embodiments include only examples and should not be taken as a limitation on the scope of the invention. For example, although at least some of the examples described in this application deal with financial services (e.g., business banking, retail banking, mortgages), the disclosed technologies are not limited to use with or in any particular industry or sector. Rather, the invention is defined by the following claims and their equivalents. We therefore claim as the invention all such embodiments and equivalents that come within the scope of these claims.

We claim:

1. One or more computer-readable media comprising instructions configured to cause a computer to perform a method, the method comprising:
reading a description of a user interface element associated with a user interface;
reading a description of a business group associated with the interface; and
displaying the user interface element in the user interface based at least in part on the business group associated with the interface.

2. The one or more computer-readable media of claim 1, wherein displaying the user interface element based at least in part on the business group associated with the interface comprises:
displaying the user interface element as a first element type if the business group associated with the user interface is a first business group; and
displaying the user interface element as a second element type if the business group associated with the user interface is a second business group, wherein the first and second element types are different.

3. The one or more computer-readable media of claim 2, wherein the description of the user interface element identifies the first and second element types.

4. The one or more computer-readable media of claim 1, wherein displaying the user interface element based at least in part on the business group associated with the user interface comprises rendering the user interface element based at least in part on one or more business rules associated with the business group.

5. The one or more computer-readable media of claim 1, further comprising displaying the user interface element based at least in part on an indication of a platform on which the user interface is configured to run.

6. The one or more computer-readable media of claim 5, wherein the user interface element is configured to be displayed as a first element type if the user interface is configured to run on a first platform, and wherein the user interface element is configured to be displayed as a second element type if the user interface is configured to run on a second platform.

7. The one or more computer-readable media of claim 1, wherein the user interface element is configured to accept a first input type if the business group associated with the interface is a first business group, and wherein the user interface element is configured to accept a second input type if the business group associated with the interface is a second business group, wherein the first and second input types are different.

8. The one or more computer-readable media of claim 1, wherein the user interface is associated with a user interface workflow, and wherein the user interface element is displayed based at least in part on the interface workflow.

9. One or more computer-readable media comprising instructions configured to cause a computer to perform a method, the method comprising:
reading a description of a user interface element associated with a user interface;
reading a description of a business rule associated with the user interface element; and
displaying the user interface element in the user interface based at least in part on the business rule associated with the user interface element.

10. The one or more computer-readable media of claim 9, wherein the business rule indicates that the user interface element should not be displayed in the user interface unless a given condition is satisfied.

11. A system comprising:
a first computer configured to run a software tool for modifying a user interface, wherein the user interface is associated with one or more business groups;
a second computer configured to receive instructions from a user and provide the instructions to the first computer; and
one or more computer-readable media comprising descriptions of elements that can be included in the user interface, wherein the descriptions associate one or more element aspects with the one or more business groups.

12. The system of claim 11, wherein the software tool is configured to receive a user role indicator and, based at least in part on the user role indicator, make available to the user one or more elements for inclusion in the user interface.

13. The system of claim 11, wherein the software tool is configured to receive a user role indicator and, based at least in part on the user role indicator, limit degree to which the user can modify the user interface.

14. The system of claim 11, further comprising one or more devices configured to receive and display the user interface.

15. The system of claim 11, further comprising a translation component configured to receive a description of a new user interface element and add a translated version of the new user interface element to the one or more computer-readable media.

16. The system of claim 11, wherein the software tool is configured to simulate at least a portion of the user interface.

17. The system of claim 11, wherein the system comprises a presentation layer, a business layer and a persistence layer.

18. One or more computer-readable media comprising a software description of a user interface element, the software description comprising:
an indication of a first business group;
a description of a first element behavior associated with the first business group;
an indication of a second business group; and
a description of a second element behavior associated with the second business group, wherein the first element behavior is different from the second element behavior.

19. The one or more computer-readable media of claim 18, wherein at least one of the first or second element behaviors is associated with a platform type for a user interface.

20. The one or more computer-readable media of claim 18, further comprising a description of a business rule associated with the user interface element.

21. The one or more computer-readable media of claim 18, comprising a third element behavior associated with a first user type and a fourth element behavior for a second user type.
